(19) United States
(12) Patent Application Publication
(10) Pub. No.: US 2012/0203428 A1
(43) Pub. Date: Aug. 9, 2012

(54) ROAD PROFILE SCANNING METHOD AND VEHICLE USING SIDE FACING SENSORS

(75) Inventors: Dave Choi, Utsunomiya (JP); Mark D. Herbert, Dublin, OH (US); Victor Flores, Dublin, OH (US)

(73) Assignee: Honda Motor Co., Ltd

(21) Appl. No.: 13/023,059

(22) Filed: Feb. 8, 2011

(51) Int. Cl. G06F 7/00; G06F 19/00; B60G 17/015

(52) U.S. Cl. 701/37; 702/150

(57) ABSTRACT

A motor vehicle and methods are presented in which side facing laser scanner sensors are used to detect road profile conditions and road obstructions in adjacent lanes and the profile information is used to update a central database for active suspension control in vehicles subsequently traveling along the scanned roadway.

### BACKGROUND

The present disclosure relates generally to roadway profile condition detection and vehicle suspension controls. Conventional reactive vehicle suspension systems adjust suspension parameters after detection of bumps or other adverse road conditions. Advanced proactive systems have been proposed to continuously monitor vehicle and road conditions to modify vehicle suspension settings in advance of detectable anomalies. The vehicle is equipped with an on-board sensor system capable of scanning the road surface in front of the vehicle, and the suspension can be adjusted according to the detected road conditions. However, front-facing sensors often become covered with mud splashes or otherwise lose the ability to accurately detect upcoming road conditions. A need therefore exists for improved road profile detection techniques and apparatus for controlling vehicle suspension parameters.

### SUMMARY

Various details of the present disclosure are hereinafter summarized to facilitate a basic understanding, where this summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter.

A motor vehicle is provided in accordance with one or more aspects of the present disclosure, which includes a vehicle body extending axially from a rear side to a front side and laterally between first and second lateral sides. The vehicle includes one or more side facing road profile sensors mounted to one of the lateral sides. The sensor detects a road surface profile and/or a road obstruction in a sensing field that extends laterally outward of the corresponding lateral side and extends at least partially rearward of the front of the vehicle. A positioning or location system determines a current vehicle position and a road profile data acquisition system receives the current vehicle position as well as a profile sensor signal or value indicating a sensed road surface profile or sensed road obstruction in the sensing field. A transceiver transmits location and detected profile data indicating the sensed road surface profile or sensed road obstruction in the sensing field as well as the current vehicle position at the time the road surface profile or road obstruction was sensed.

In certain embodiments the road profile sensor is a laser scanner, but other sensor types can be used. In certain embodiments, the sensing field extends at least partially into an adjacent road lane, thus facilitating scanning of lanes to be encountered by other vehicles, including lanes with traffic moving in the opposite direction. Certain embodiments may provide multiple side-facing profile sensors, which may provide sensing field coverage for both lateral sides of the vehicle and/or enhanced coverage along one side, and the side facing sensor(s) may be used in conjunction with one or more forward facing road profile sensors mounted to sense a road surface profile or a road obstruction in a forward facing sensing field.

In certain embodiments, the transceiver transmits the location and detected profile data addressed to a server for updating a road profile data store. This external data store can then be accessed by other vehicles for use in active suspension control. In certain embodiments, moreover, the RF transceiver is operative to transmit the location and detected profile data addressed to a server associated with a public service provider, such as police, EMS, state department of transportation entities, etc., particularly where the location and detected profile data indicates a sensed road obstruction.

In certain embodiments, the vehicle includes a memory with a local road profile data store, and the data acquisition system provides the location and detected profile data to the memory to update the road profile data. This allows the vehicle to perform proactive suspension control using the on-board data, and allows for subsequent transfer from the on-board database to a centralized database for use of the updated information by others.

In certain embodiments, the vehicle includes suspension systems individually associated with a corresponding vehicle wheel, which are operated by control signals or values to selectively stiffen or loosen the suspension. A suspension controller obtains the current vehicle position from the GPS system, and obtains road profile data from a local road profile data store or via the radio frequency transceiver from an external road profile data store. The controller provides the suspension control signals or values to the suspension systems based in whole or in part on the road profile data and the current vehicle position.

In certain embodiments, the positioning system includes a GPS system, which may be augmented with one or more auxiliary refinement systems or techniques to provide a highly accurate position determination. In certain embodiments, the positioning system determined the vehicle position at least partially according to road surface matching, vehicle-to-vehicle triangulation, landmark triangulation, detection of exact position markers embedded within a road surface, and/or by dead reckoning techniques using gyro/accelerometer/speed pulse data.

In accordance with further aspects of the disclosure, a road profile mapping method is provided, which includes mounting one or more side facing road profile sensors to a lateral side of a motor vehicle, with a sensing field extending laterally outward of the lateral side of the vehicle and at least partially rearward of the vehicle front. The method further includes sensing a road surface profile or a road obstruction in the sensing field, as well as updating a road profile data store with detected profile data indicating the sensed road surface profile or obstruction in the sensing field and the current vehicle position at the time the road surface profile or road obstruction was sensed. Updating the data store in certain embodiments includes transmitting the location and detected profile data addressed to an external server for updating a road profile data store, and in certain embodiments includes providing the location and detected profile data to a vehicle memory to update an internal road profile data store. Certain embodiments of the method, moreover, include transmitting the location and detected profile data addressed to an external server associated with a public service provider.

Further aspects of the disclosure involve a method for detecting road obstructions. The method includes mounting a road profile sensor to a motor vehicle with a sensing field extending onto a road proximate the motor vehicle, sensing a road obstruction in the sensing field of the road profile sensor, and transmitting data addressed to a server associated with a public service provider, where the data indicates the sensed road obstruction in the sensing field and the current vehicle position at the time the road obstruction was sensed.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIG. 1A is a partial schematic system diagram illustrating an exemplary motor vehicle with proactive suspension control and side facing road scanning apparatus for road profile mapping in accordance with one or more aspects of the disclosure;

FIG. 1B is a top plan view illustrating the vehicle of FIG. 1A traveling along a roadway with front and side facing laser scanners sensing road profile conditions and obstructions in front, and to the sides, of the vehicle;

FIG. 2A is a simplified system diagram illustrating several vehicles of the type shown in FIGS. 1A and 1B transmitting location and detected profile data from on-board road scanning sensor and data acquisition apparatus to a networked server hosting a central road profile database;

FIG. 2B is a simplified system diagram illustrating the vehicles obtaining road profile data from the central road profile database for use in proactive vehicle suspension control;

FIG. 3A is a partial schematic top plan view illustrating a first side-scanner equipped vehicle detecting anomalies in an adjacent lane and sending corresponding location and detected profile data by wireless signaling to the central road profile database, as well as a second vehicle with an inoperative front scanner obtaining corresponding road profile data for the second lane from the central road profile database allowing the second vehicle to initiate proactive vehicle suspension control before encountering the anomalies detected by the first vehicle;

FIG. 3B is a partial schematic top plan view illustrating a first side-scanner equipped vehicle detecting an obstruction in an adjacent lane and sending corresponding location and detected profile data to the central road profile database and to a police server; and

FIG. 3C is a partial schematic top plan view illustrating a first side-scanner equipped vehicle travelling in a first direction while detecting anomalies in an adjacent lane and sending corresponding location and detected profile data to the central road profile database, with a second vehicle traveling in an opposite direction in the second lane using road profile data from the central road profile database for proactive vehicle suspension control.

### DETAILED DESCRIPTION

One or more embodiments or implementations are hereinafter described in conjunction with the drawings, where like reference numerals are used to refer to like elements throughout, and where the various features are not necessarily drawn to scale. The disclosure relates to vehicle road profile detection systems using side-facing sensors for mapping road conditions and to use of road profile data for advanced suspension control. The disclosed features may be implemented in a variety of vehicle types having two or more wheels and a propulsion system, and the disclosure is not limited to the illustrated embodiments.

The disclosure provides an advance over conventional reactive vehicle suspension systems which adjust suspension parameters only after detection of bumps or other adverse road conditions, and provides for road profile information facilitating proactive vehicle suspension control that may employ an external database for advanced communicative vehicle dynamics. The disclosure finds particular utility in vehicle suspension control systems that continuously monitor vehicle and road conditions in order to create the best vehicle suspension settings in advance of detectable or known road conditions, where the vehicle is equipped with an on-board laser system capable of scanning the road surface to the sides of the vehicle. The side facing laser scanners map the road profile for future use and forward scanning lasers can provide real time road condition information.

In certain implementations, the detected road condition information can be saved to an on-board data store and/or can be relayed to a networked server database through Honda Inter-NAVI or other wireless (e.g., RF) communications link(s), such as a customer 3G phone or home WI-FI interface, etc. An on-board GPS system determines the current vehicle location and the externally obtained or on-board information can be matched to the location and expected upcoming route along a travelled road. In some embodiments, the suspension system adjusts the dampening characteristics to better handle the road conditions, and the system may compensate for other factors such as vehicle speed, on-board weight, tire pressure, etc. The road profile information can be used exclusively for vehicles lacking on-board scanners or in situations where one or more scanners become inactive, such as by mud or debris obstructing the lenses. In addition, road condition information collected by one vehicle can be used by another to adjust the suspension in anticipation of road conditions, even where the vehicles are travelling in opposite directions and/or in different lanes. The vehicle systems can be used to construct a database profile of entire roads and particular lanes thereof, so that the vehicle suspension would be aware of road conditions of an entering lane that may affect its stability. Extreme road issues such as obstructions that can result in injury to other drivers, such as dead animals and large pot holes, can be relayed to the local department of transportation, police, or other public service entity.

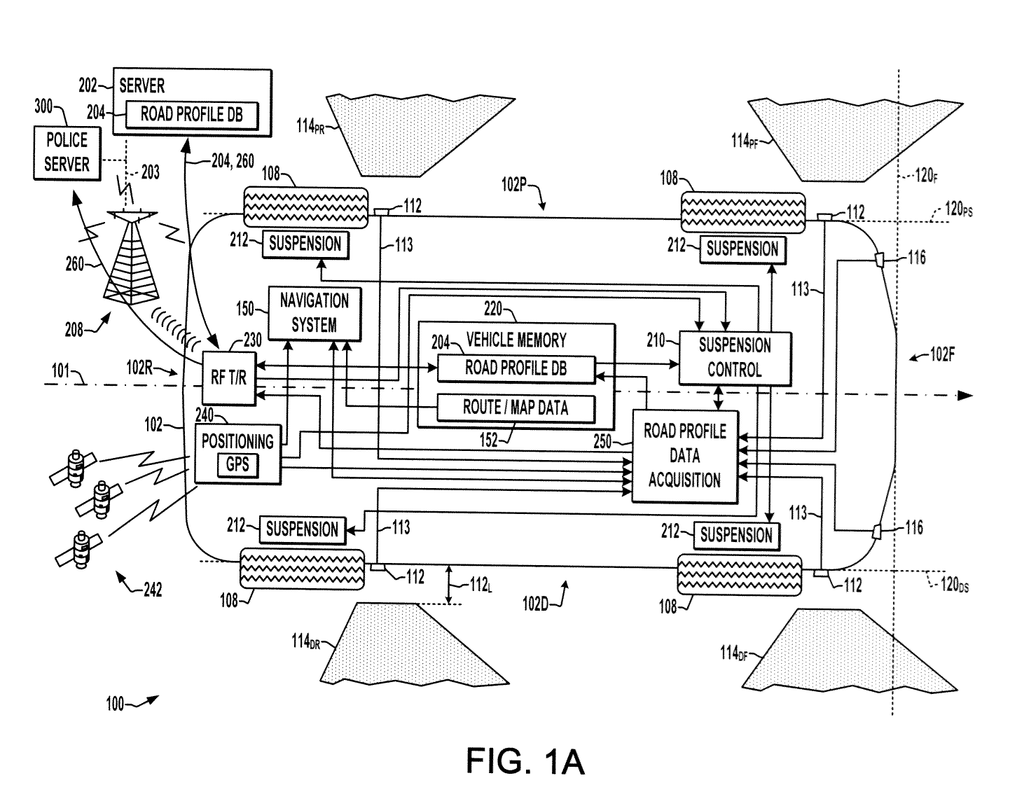

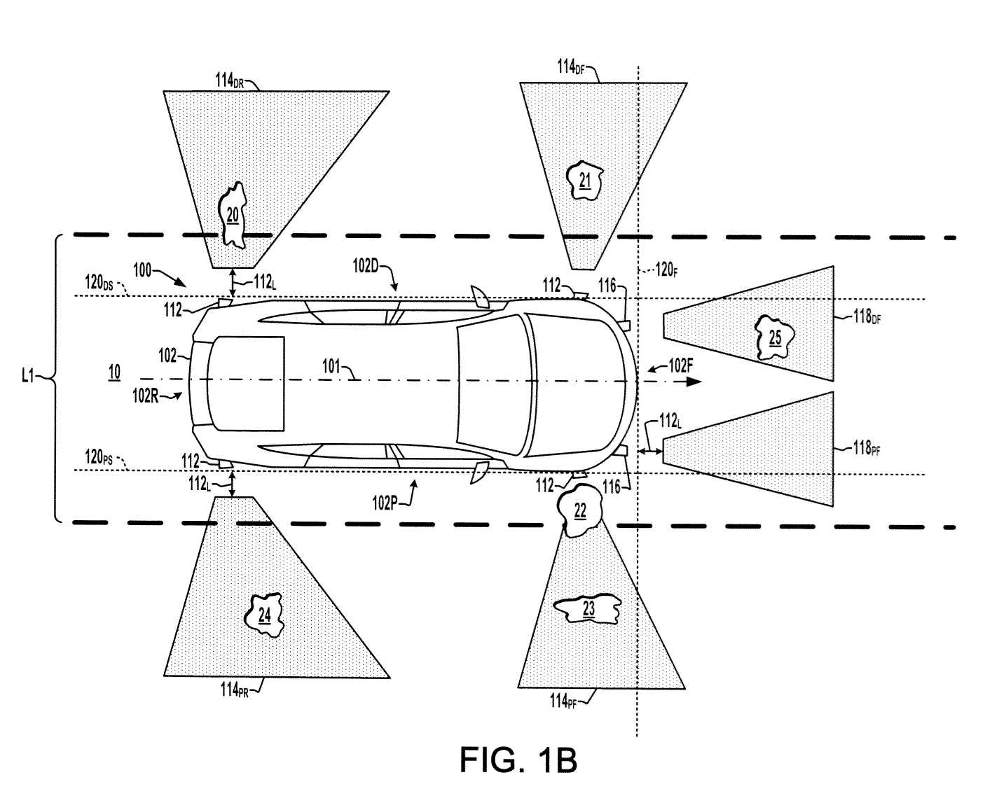

An exemplary vehicle 100 is shown in FIGS. 1A and 1B with a vehicle body 102 extending along a vehicle axis 101 (FIG. 1A) from a rear side 102R to a front side 102F and extending side to side (laterally of the axis 101) between a driver side 102D and a passenger side 102P, with the front 102F extending to a front line 120F lateral to the axis 101 and the driver and passenger sides 102D, 102P extending laterally to side lines 120DS and 120PS, respectively. The vehicle 100 includes wheels 108, one or more of which are driven by a propulsion system having an internal combustion engine and/or electric drive apparatus (not shown). One or more of the wheels 108 are mounted to the vehicle body 102 via a corresponding suspension system 212, and the suspensions 212 are individually or jointly operated by a suspension control system 210 which provides control signals and/or values to the suspension systems 212 for active suspension control in the vehicle 100. The suspension systems 212 are situated between the corresponding wheels 108 and the vehicle body, and operate according to the suspension control signals or values to extend and retract the vehicle body relative to the wheels 108. The suspension systems 212 in certain embodiments include a suspension spring and a hydraulic actuator (not shown) arranged in parallel between the vehicle body and the corresponding wheel 108 by which the hydraulic actuator operates by an associated valve to selectively stiffen or loosen the suspension 212.

The vehicle 100 further includes an on-board navigation system 150 and a location or positioning system 240, and the navigation system 150 may include or be operatively coupled with a user interface (not shown) having a display and audio output capability, as well as user input devices such as buttons, touch-screen display controls, voice activation features, etc. In certain embodiments, the positioning system includes a GPS system receiving signals and data from GPS satellites 242 as shown in FIG. 1A. The system 240 may alternatively use other position estimation techniques and/or may augment the GPS position estimate with such techniques to provide a highly accurate position determination, including without limitation road surface matching, vehicle-to-vehicle triangulation, landmark triangulation, detection of exact position markers embedded within a road surface, and/or by dead reckoning techniques using gyro/accelerometer/speed pulse data. The navigation system 150 generally operates according to user-entered destination information and preferences information, and interfaces with the location/positioning system 240 to ascertain the current vehicle position, for instance, by appropriate signaling from GPS satellites 242 and possibly with supplementation by one or more of the above mentioned techniques to provide a highly accurate refined estimate of the vehicle's position. The navigation system 150 may also receive inputs from one or more further sensors, such as a gyro sensor (not shown) and also communicates with a propulsion controller, for instance, to obtain current vehicle speed information and status information regarding the propulsion system status.

The vehicle 100 in certain embodiments thus provides a highly accurate positioning system 240 and can be equipped with suitable sensors, processing, and communications elements to implement road surface matching along or to augment GPS data, as well as vehicle-to-vehicle triangulation, for instance with relative time differences being used to determine how close another car is to a particular spot in the road, landmark triangulation (e.g., to a building), and or using exact position markers embedded within the road surface, and/or the positioning system 240 can include one or more gyro/accelerometer/speed pulse data sensors/detectors to perform dead reckoning of the current vehicle position to provide sufficient accuracy.

In certain embodiments, moreover, GPS techniques can be employed by the positioning system 240 to generate an initial rough estimate of the location of an identified or suspected road obstruction. With this, the system 250 can assess the severity of the road impediment (e.g., size, position, shape, etc.) and selectively determine whether to ignore it or take further action, such as initiating active scanning, reporting, etc. In this manner, the system 250 can conserve energy and resource utilization as the system will not need to scan the road 100% of the time.

Referring also to FIG. 1B, in accordance with various aspects of the present disclosure, the exemplary vehicle 100 includes one or more road profile sensors 112, 116, which can be any form or type of sensor operative to sense or detect the profile of a road surface 10 within a corresponding sensor field 114, 118, including the presence or absence of obstructions, surface contour, depressions, cracks, holes, debris, water, snow, ice, etc. In certain embodiments, the sensors 112, 116 can be laser scanners that direct laser outputs along scan paths and measure reflected light to optically sense the road surface conditions in the corresponding sensor fields 114, 118. The scanners 112, 116 can also detect the presence or absence of road obstructions, such as animals, fallen trees, spilled cargo, disabled vehicles, large holes, etc.

The exemplary vehicle 100 includes two side facing road profile sensors 112 mounted to each of the lateral sides 102D, 102P. The side-facing sensors 112 sense the road surface profile and/or road obstructions in a corresponding sensing field 114. In this embodiment, front and read driver-side sensors 112 sense the conditions in corresponding sensing fields 114_{DF} and 114_{DR} and passenger-side sensors 112 sense the conditions in corresponding sensing fields 114_{PF} and 114_{PR}. Other embodiments can include any number of one or more side-facing sensors that are positioned to sense or detect the profile of a road surface including the presence or absence of obstructions in a corresponding sensor field 114 extending laterally outward of the corresponding lateral vehicle side 102D, 102P and at least partially rearward of the front side 102F of the vehicle body 102.

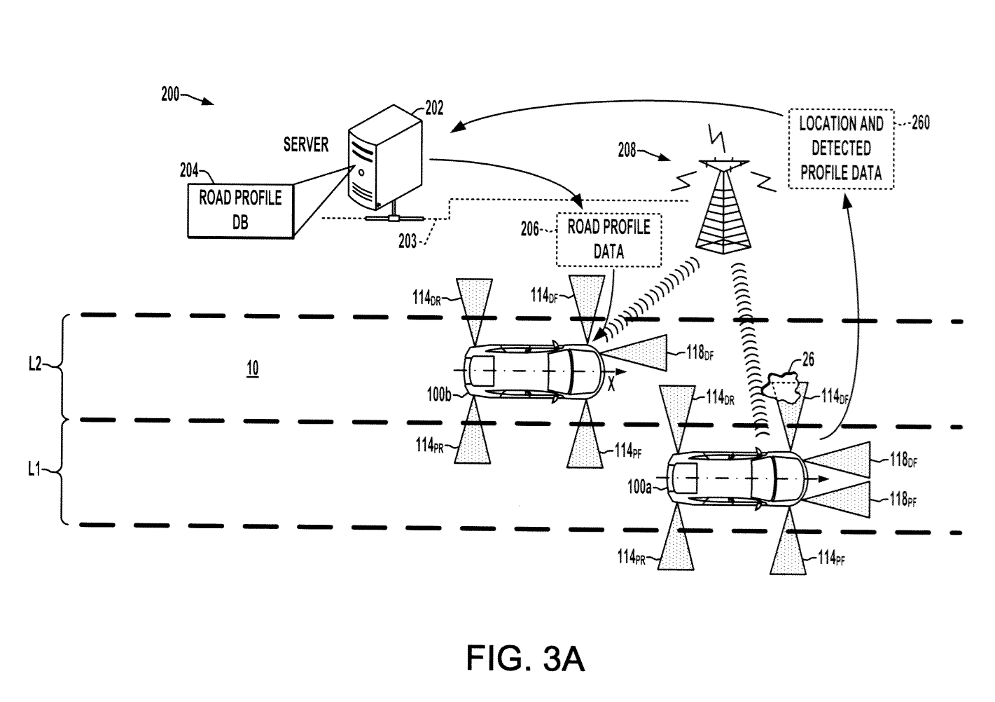

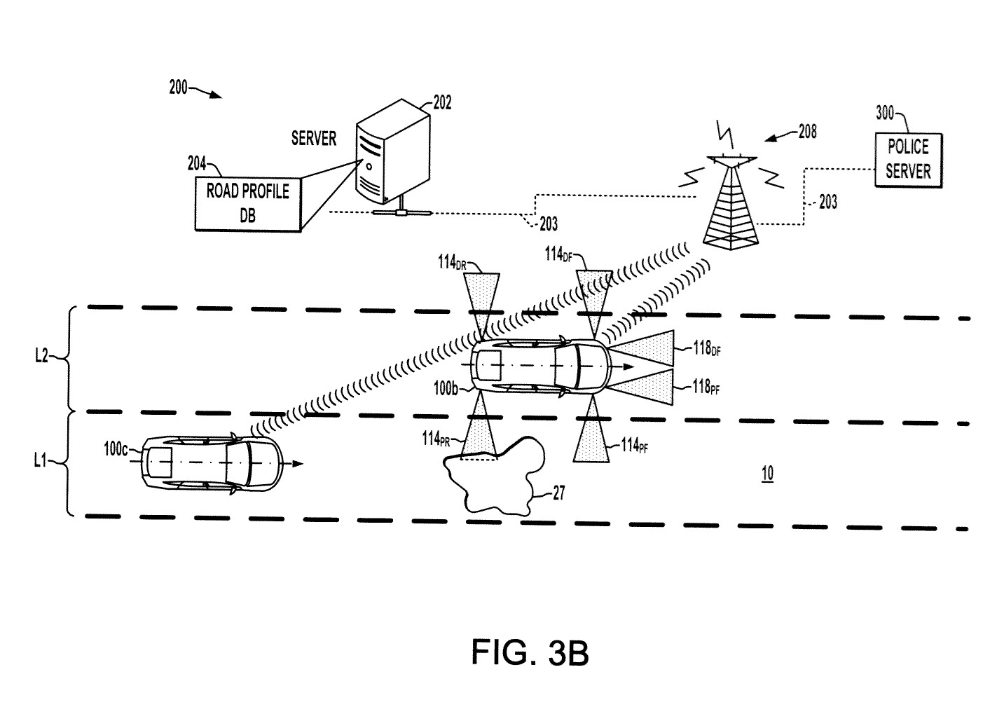

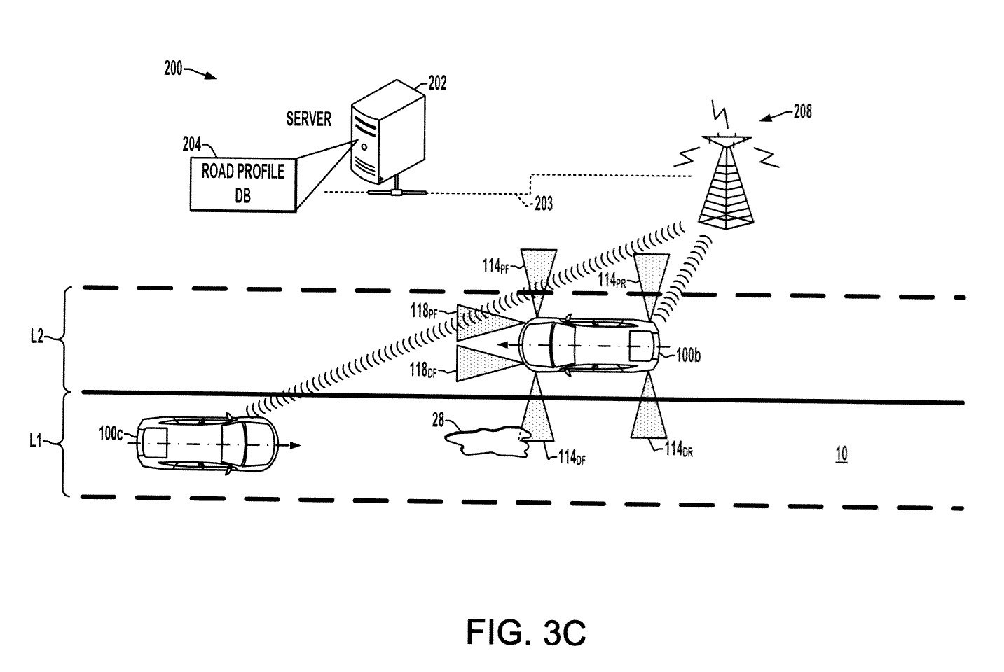

The illustrated vehicle 100 further includes forward facing road profile sensors 116 mounted to the front side 102F and operative to sense a road surface profile or a road obstruction in corresponding driver and passenger side forward facing sensing fields 118_{DF} and 118_{PF} extending at least partially forward of the front side 102F of the vehicle body 102. As seen in FIG. 1B, this allows detection of anomalies 25 in the travelled lane L1 of the road 10. Moreover, the sensing fields 114 of the side facing road profile sensors 112 extend at least partially into an adjacent road lane. Thus, when the vehicle 100 is traveling along the road 10 in a first lane L1, the side facings sensors 112 detect road profile anomalies 20-24 and obstructions that are wholly or partially in adjacent lanes, as detailed further below in connection with FIGS. 3A-3C. The sensing fields 114, 118 of the sensors 112, 116, moreover, may not extend to the side/front lines 120, but may instead begin a distance 12L therefrom as shown in FIG. 1B.

The vehicle 1000 is further equipped with a radio frequency (RF) transceiver 230 which transmits and receives data to/from one or more external network elements, such as servers 202, 300 (FIG. 1A) via a wireless network including one or more base stations 208 operatively coupled with the servers 202, 300 via a communications network 203.

With continuing reference to FIG. 1A, the positioning system 240 determines the current vehicle position and provides this location information to the navigation system 150 and the suspension control system 210, as well as to a road profile data acquisition system 250. The data acquisition system 250 is operatively coupled with the positioning system 240, the navigation system 150, and the suspension control system 210, and receives profile sensor signals or values 113 from the side facing road profile sensors 112 which indicate sensed road surface profile and/or sensed road obstructions in the corresponding sensing fields 114, and likewise receives sensor signals or values from the front facing sensors 116. The data acquisition system 250 also receives the current vehicle position from the positioning system 240.

The vehicle 100 also includes a vehicle memory 220 storing route/map data 152 used and maintained by the navigation system 150. The memory 220 further includes a local road profile data store 204 used for active suspension control in the vehicle 100 and maintained/updated with road condition information (profile data) 206 obtained from the data acquisition system 250 and/or from an external data store 204.

In operation, the road profile data acquisition system 250 provides location and detected profile data 260 to the memory 220 to update the road profile data store 204, where the data 260 is indicative of the sensed road surface profile or sensed road obstruction in the sensing field 114 and the current vehicle position at the time the road surface profile or road obstruction was sensed. The data acquisition system 250 also provides the location and detected profile data 260 to the RF transceiver 230, which transmits the location and detected profile data 260 to the wireless network addressed to an external server 202 for updating a central road profile data store 204. Thus, the road conditions sensed by the vehicle 100 can be stored in the central database 204 for access and use by other vehicles traveling along the road sensed by the vehicle 100. The RF transceiver 230 in certain embodiments transmits the location and detected profile data 260 addressed to a server 300 associated with a public service provider, such as police, EMS, transportation department, etc., including the location and characteristics of a sensed road obstruction 27, as described further below in connection with FIG. 3B.

The suspension control system 210, the navigation system 150, and the road profile data acquisition system 250 can be implemented as any suitable hardware, processor-executed software, processor-executed firmware, programmable logic, or combinations thereof, and may separately implemented with suitable interconnections or one or more of these systems may be integrated with one another and/or with other vehicle systems, such as with a propulsion control system (not shown) of the vehicle 100.

In addition to sensing road conditions for updating the internal and/or external road profile data stores 204, the suspension controller 210 can use this locally stored data 204 and/or data obtained from the external database 204, along with the current vehicle position from the positioning system 240, for active suspension control. In operation, the suspension controller 210 obtains road profile data 206 from either or both of the local road profile data store 204 or the external road profile data store 204 (via the radio frequency transceiver 230) which indicates road profile data 206 for an expected road surface profile and expected road obstructions for expected upcoming vehicle locations along a travelled route. With this, the suspension controller 210 provides the suspension control signals or values to the suspension systems 212.

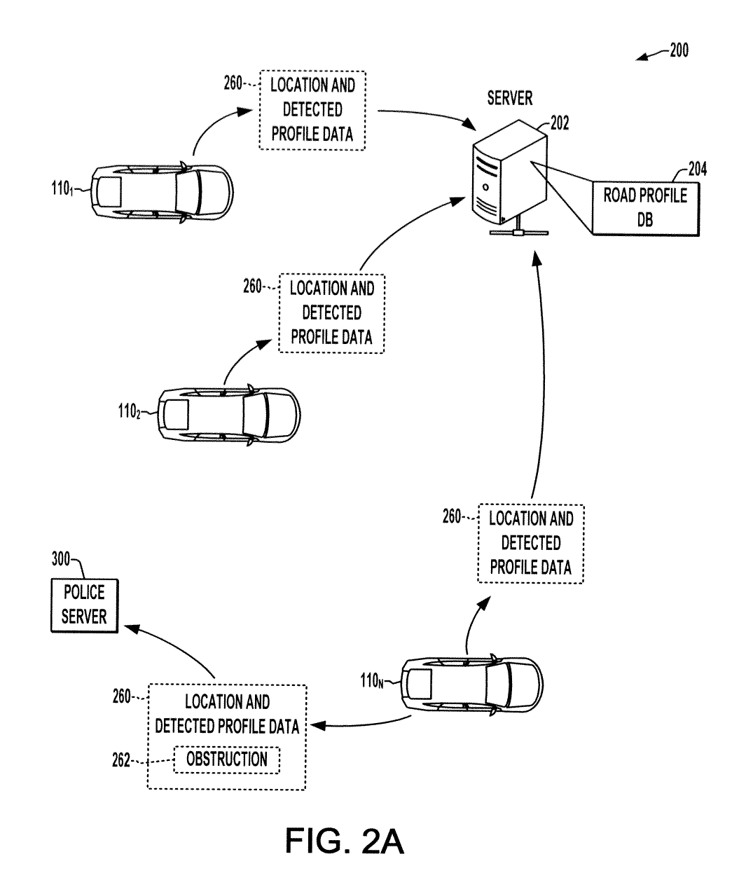

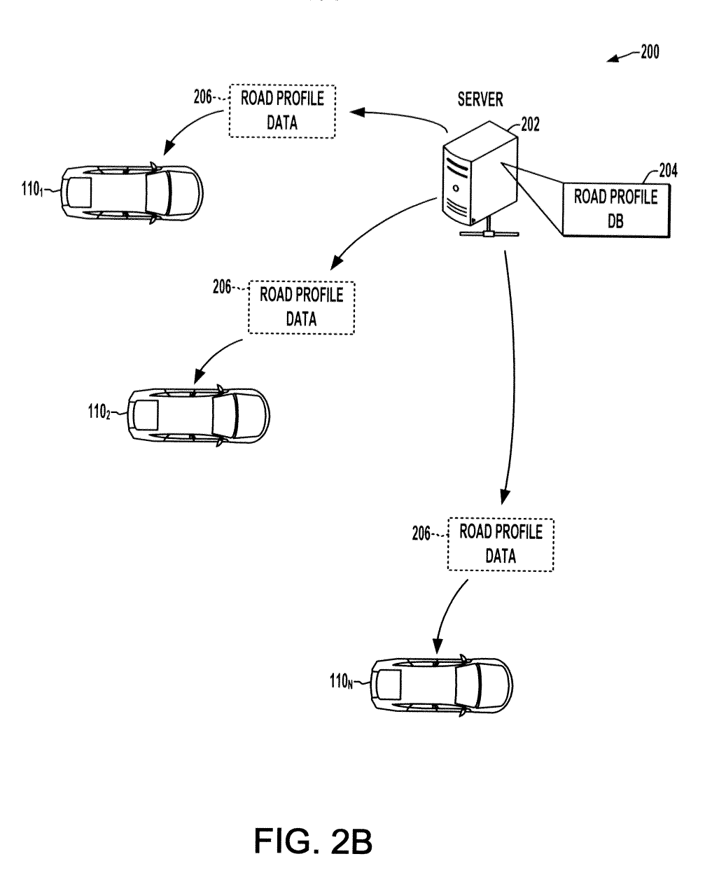

Referring also to FIGS. 2A-3C, the central database 204 and the vehicles 100 having the sensor equipment 112, 116, data acquisition systems 250 and RF transceivers 230 constitute a road scanning or road mapping system 200 providing information that can be used by vehicles for proactive suspension control, as well as for reporting road conditions such as obstructions 27 to police or other appropriate authorities or service providers.

FIG. 2A illustrates several vehicles 100₁-100_{N} equipped with sensors 112 and a data acquisition system 250 as described above. The vehicles 100 travel along various roads and lanes thereof, and detect road profile and obstruction information for locations travelled. The vehicles 100, moreover, continuously or periodically use their on-board RF transceivers 230 to transmit location and detected profile data 260 from the on-board road scanning sensors 112 and GPS information to the networked server 202 hosting the central road profile database 204, where the transmitted data 260 indicates the sensed road surface profile or sensed road obstruction in the sensing field 114 of a given sensor and the current vehicle position at the time the road surface profile or road obstruction was sensed.

The transmission data 260 in certain embodiments includes location adjustment offsets or other specific information by which the location of the corresponding sensor field 114 is specified or can be determined. Thus, if the GPS data indicates a single global position for the vehicle 100, the data 260 can individually indicate the position of the specific sensor field 114 (or 118) to which the sensed road surface profile or sensed road obstruction corresponds, based on which sensor 112 (or 116) detected the relayed road condition. As further shown in FIG. 2A, the vehicles 100 can report the data 260 including detected road obstructions 262 and corresponding position information via RF transmission addressed to the public service server 300.

In this manner, the scanning vehicle 100 can determine road conditions for a travelled road lane as well as for adjacent lanes, and this information can be sent to the server 202 for updating the central database 204. FIG. 2B illustrates the vehicles 100 obtaining road profile data 206 from the central road profile database 204 for use in proactive vehicle suspension control or for any other purpose. In certain embodiments of the illustrated vehicle 100, the suspension controller 210 (FIG. 1A) obtains the current vehicle position from the positioning system 240, and obtains road profile data 206 from the external road profile data store 204 via the RF transceiver 230 and the various networks and server 202. The requested and obtained data 206 may be a download of a complete set of data for a particular road/route or may be a continuous stream of particularized data 206 indicating an expected road surface profile and expected road obstructions for expected upcoming vehicle locations along a designated travelled route. The suspension controller 210 can then provide the suspension control signals or values to the suspension systems 212 at least partially according to the road profile data 206 and the current vehicle position for proactive control of the vehicle suspension and driving performance.

FIGS. 3A-3C illustrate operation of the system 200 for both road profile data gathering and for active vehicle suspension control. FIG. 3A shows a first side-scanner equipped vehicle 100a traveling in a first direction (left-to-right in the figure) along a first lane L1 of a road having two lanes L1 and L2 for travel in the first direction. The first vehicle 100a detects road conditions including identification of an anomaly 26 in the adjacent lane L2, in this case using a side facing sensor 112 having a corresponding sensor field 114. In this particular, case, the first vehicle 100a senses the road anomaly 26 prior to a second vehicle 100b reaching the anomaly 26 in the second lane L2. In this example, moreover, the second vehicle 100b has an inoperative front scanner 116 (or may not have sensors), but nevertheless includes proactive suspension control equipment. The first vehicle 100a sends corresponding location and detected profile data 260 by wireless signaling to the central road profile database 204 and the second vehicle 100b obtains corresponding road profile data 206 for the second lane L2 of the travelled road 10 from the database 204, and the second vehicle 100b initiates proactive vehicle suspension control before encountering the anomaly 26.

FIG. 3B shows another situation in which a first vehicle 100b traveling in lane L2 of the road 10 detects an obstruction 27, such as a large hole in an adjacent lane L1, and sends corresponding location and detected profile data 260 to the central road profile database 204 and also to a police server 300. A second vehicle 100c (which may not have road sensors 112, 116) is traveling along the lane L1 and obtains road profile data 206 from the server database 204, including the identification and location of the obstruction 27. In this situation, the vehicle 100c, if suitably equipped, can automatically adjust its suspension 212 by operation of an on-board active suspension control system 210 to accommodate driving over the obstructions 27. Alternatively or in combination, an on-board navigation system 150 in the second vehicle 100c can use the road profile data 206 to warn the driver and recommend changing to lane L2 ahead of time to avoid the obstruction 27. Moreover, the detection and reporting of the obstruction 27 by the first vehicle 100b advantageously allows police or other public service entity to go to the site of the obstruction 27 and take appropriate action, such as closing lane L1.

FIG. 3C illustrates a further exemplary scenario in which a first vehicle 100b is travelling in one direction (right-to-left in the figure) along a lane L2 while detecting road conditions using side facing scanner(s) 112 in an adjacent lane L1. This vehicle 100b detects a road anomaly 28 situated in the lane L1 and sends corresponding location and detected profile data 260 to the central road profile database 204. A second vehicle 100c traveling in the opposite direction (left-to-right) in the lane L1 obtains road profile data 206 from the central database 204 corresponding to its upcoming route along the road 10 and uses the data 206 for proactive vehicle suspension control before encountering the detected anomaly 28.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A motor vehicle, comprising:
a vehicle body extending along a vehicle axis from a rear side to a front side and extending between first and second lateral sides;
at least one side facing road profile sensor mounted to one of the first and second lateral sides and operative to sense a road surface profile or a road obstruction in a sensing field extending laterally outward of the one of the first and second lateral sides and at least partially rearward of the front side of the vehicle body;
a positioning system operative to determine a current vehicle position;
a road profile data acquisition system operative to receive a profile sensor signal or value from the side facing road profile sensor indicating a sensed road surface profile or sensed road obstruction in the sensing field and to receive the current vehicle position from the positioning system; and
a radio frequency transceiver operative to transmit location and detected profile data indicative of the sensed road surface profile or sensed road obstruction in the sensing field and the current vehicle position at the time the road surface profile or road obstruction was sensed.

2. The motor vehicle of claim 1, where the sensing field of the at least one side facing road profile sensor extends at least partially into an adjacent road lane.

3. The motor vehicle of claim 1, where the radio frequency transceiver is operative to transmit the location and detected profile data addressed to a server for updating a road profile data store.

4. The motor vehicle of claim 3, where the radio frequency transceiver is operative to transmit the location and detected profile data addressed to a server associated with a public service provider, the location and detected profile data indicating a sensed road obstruction.

5. The motor vehicle of claim 1, where the radio frequency transceiver is operative to transmit the location and detected profile data addressed to a server associated with a public service provider, the location and detected profile data indicating a sensed road obstruction.

6. The motor vehicle of claim 1, comprising a memory including local road profile data store, where the road profile data acquisition system is operative to provide the location and detected profile data to the memory to update the road profile data store.

7. The motor vehicle of claim 1, comprising:
a plurality of suspension systems individually associated with a corresponding vehicle wheel and operative according to suspension control signals or values to selectively stiffen or loosen the suspension system of the corresponding vehicle wheel; and
a suspension controller operative to obtain the current vehicle position from the positioning system, and to obtain road profile data from a local road profile data store or via the radio frequency transceiver from an external road profile data store, the road profile data indicating an expected road surface profile and expected road obstructions for expected upcoming vehicle locations along a travelled route, the suspension controller being operative to provide the suspension control signals or values to the suspension systems at least partially according to the road profile data and the current vehicle position.

8. The motor vehicle of claim 1, comprising a plurality of side facing road profile sensors individually mounted to one of the first and second lateral sides and individually operative to sense a road surface profile or a road obstruction in a corresponding sensing field extending laterally outward of the corresponding one of the first and second lateral sides and at least partially rearward of the front side of the vehicle body.

9. The motor vehicle of claim 8, where a first one of the plurality of side facing road profile sensors is mounted to the first lateral side and a second one of the plurality of side facing road profile sensors is mounted to the second lateral side.

10. The motor vehicle of claim 1, comprising at least one forward facing road profile sensor mounted to the front side and operative to sense a road surface profile or a road obstruction in a forward facing sensing field extending at least partially forward of the front side of the vehicle body.

11. The motor vehicle of claim 1, where the at least one side facing road profile sensor is a laser scanner.

12. The motor vehicle of claim 1, where the positioning system comprises a GPS system.

13. The motor vehicle of claim 1, where the positioning system is operative to determine the current vehicle position at least partially according to road surface matching.

14. The motor vehicle of claim 1, where the positioning system is operative to determine the current vehicle position at least partially according to vehicle-to-vehicle triangulation.

15. The motor vehicle of claim 1, where the positioning system is operative to determine the current vehicle position at least partially according to landmark triangulation.

16. The motor vehicle of claim 1, where the positioning system is operative to determine the current vehicle position at least partially according to detection of exact position markers embedded within a road surface.

17. The motor vehicle of claim 1, where the positioning system is operative to determine the current vehicle position at least partially by dead reckoning using gyro/accelerometer/speed pulse data.

18. A method for mapping road profiles, the method comprising:
mounting at least one side facing road profile sensor to a lateral side of a motor vehicle with a sensing field extending laterally outward of the lateral side of the motor vehicle and at least partially rearward of a front side of the motor vehicle;
sensing a road surface profile or a road obstruction in the sensing field of the side facing road profile sensor;
determining a current vehicle position using a positioning system; and
updating a road profile data store with detected profile data indicative of the sensed road surface profile or sensed road obstruction in the sensing field and the current vehicle position at the time the road surface profile or road obstruction was sensed.

19. The method of claim 18, where updating the road profile data store comprises transmitting the location and detected profile data addressed to an external server for updating a road profile data store.

20. The method of claim 18, where updating the road profile data store comprises providing the location and detected profile data to a vehicle memory to update an internal road profile data store.

21. The method of claim 18, further comprising transmitting the location and detected profile data addressed to an external server associated with a public service provider, the location and detected profile data indicating a sensed road obstruction.

22. A method for detecting road obstructions, the method comprising:
mounting at least one side or forward facing road profile sensor to a motor vehicle with a sensing field extending onto a road proximate the motor vehicle;
sensing a road obstruction in the sensing field of the road profile sensor;
determining a current vehicle position using a positioning system; and
transmitting data addressed to a server associated with a public service provider, the data indicative of the sensed road obstruction in the sensing field and the current vehicle position at the time the road obstruction was sensed.
